(19) United States
(12) Patent Application Publication
(10) Pub. No.: US 2024/0143486 A1
(43) Pub. Date: May 2, 2024

(54) AUTOMATED TEST CASE GENERATION USING COMPUTER VISION

(71) Applicant: International Business Machines Corporation, Armonk, NY (US)

(72) Inventors: Raju Metgiri, Dusseldorf (DE); Hemant Kumar Sivaswamy, Pune (IN); Shikhar Kwatra, San Jose, CA (US)

(21) Appl. No.: 18/050,094

(22) Filed: Oct. 27, 2022

(51) Int. Cl. G06F 11/36; G06F 16/11; G06N 3/04

(52) U.S. Cl. CPC G06F 11/3684; G06F 16/116; G06N 3/0454

(57) ABSTRACT

A computer-implemented method, a computer program product, and a computer system for using computer vision to automatically generate a unit test case. A computer converts a text file of a source code to an image file of the source code. A computer inputs the image file to a neural network having been trained with source code images. The neural network identifies elements in the image file. The neural network generates a resulting image including identified elements in the image file. A computer extracts the identified elements from the resulting image. A computer generates a text file including a key value map of the identified elements. A computer generates a scaffold of a unit test case, based on the key value map.

### BACKGROUND

The present invention relates generally to test case generation, and more particularly to using computer vision to automatically generate a test case.

Many organizations have huge codebases with little to no unit test cases written for them. With the growing demand for faster software releases and feature enhancements, it becomes imperative for these organizations to introduce continuous integration and delivery mechanisms. However, to achieve this goal, the organizations need to make sure quality of the code is maintained and there are no unintended consequences to the business-critical components, which in turn needs better unit test cases. One way to solve this issue is to hire an army of testers who write each and every unit test case. In most situations, this is prohibitively expensive, even for big companies.

### SUMMARY

In one aspect, a computer-implemented method for using computer vision to automatically generate a unit test case is provided. The method includes converting a text file of a source code to an image file of the source code. The method further includes inputting the image file to a neural network having been trained with source code images. The method further includes identifying, by the neural network, elements in the image file. The method further includes generating, by the neural network, a resulting image including identified elements in the image file. The method further includes extracting the identified elements from the resulting image. The method further includes generating a text file including a key value map of the identified elements. The method further includes generating a scaffold of a unit test case, based on the key value map.

In another aspect, a computer program product for using computer vision to automatically generate a unit test case is provided. The computer program product comprises a computer readable storage medium having program instructions embodied therewith, and the program instructions are executable by one or more processors. The program instructions are executable to convert a text file of a source code to an image file of the source code. The program instructions are further executable to input the image file to a neural network having been trained with source code images. The program instructions are further executable to identify, by the neural network, elements in the image file. The program instructions are further executable to generate, by the neural network, a resulting image including identified elements in the image file. The program instructions are further executable to extract the identified elements from the resulting image. The program instructions are further executable to generate a text file including a key value map of the identified elements. The program instructions are further executable to generate a scaffold of a unit test case, based on the key value map.

In yet another aspect, a computer system for using computer vision to automatically generate a unit test case is provided. The computer system comprises one or more processors, one or more computer readable tangible storage devices, and program instructions stored on at least one of the one or more computer readable tangible storage devices for execution by at least one of the one or more processors. The program instructions are executable to: convert a text file of a source code to an image file of the source code; input the image file to a neural network having been trained with source code images; identify, by the neural network, elements in the image file; generate, by the neural network, a resulting image including identified elements in the image file; extract the identified elements from the resulting image; generate a text file including a key value map of the identified elements; and generate a scaffold of a unit test case, based on the key value map.

### BRIEF DESCRIPTION OF THE SEVERAL VIEWS OF THE DRAWINGS

FIG. 1 illustrates a system for using computer vision to automatically generate a unit test case, in accordance with one embodiment of the present invention.

FIG. 2 is a flowchart showing operational steps of using computer vision to automatically generate a unit test case, in accordance with one embodiment of the present invention.

FIG. 3 illustrates an example of a source code in a text format, in accordance with one embodiment of the present invention.

FIG. 4 illustrates an example of elements identified by a neural network in an image of a source code, in accordance with one embodiment of the present invention.

FIG. 5 illustrates an example of a scaffold of a unit test case, in accordance with one embodiment of the present invention.

FIG. 6 is a systematic diagram illustrating an example of an environment for the execution of at least some of the computer code involved in using computer vision to automatically generate a unit test case, in accordance with one embodiment of the present invention.

### DETAILED DESCRIPTION

Embodiments of the present invention present an approach that leverages advancements in computer vision and deep neural networks to generate test case scaffolds. These test case scaffolds can then be transformed by a small number of testers to viable test cases.

To generate test cases for a large codebase, two components to work well are needed: First, scalable parsing of the source code that can extract at least the following information, including a name of a function/routine, inputs to the function/routine, a return value type, all logical branches that can occur in the function/routine (a simplest example of logical branches may be if-else statements), and externalities/dependencies to mock. Second, an application that understands rules of testing.

Humans are good at parsing source code written by others. This is possible because humans use vison and memory. The present invention leverages computer vision of neural networks such as faster R-CNN (Region-based Convolutional Neural Network) to identify various elements in source code files, making it possible to have a language agnostic and scalable parsing solution.

To use the idea of computer vision, source code files need to be converted into images, using libraries such as Pillow (a free and open-source additional library for the Python programming language). These images are fed to a neural network and then elements identified by a neural network is converted back to a text file—a key map file. This key map file can be used by a test case generator to generate test cases.

Benefits of the approach disclosed in the present invention are as follows. First, the disclosed approach is programming language agnostic. Switching from one language to another will means training computer vision on the new data set. Second, most of the solution elements in the approach disclosed in the present invention are already available; thus, the availability of the most of the solution elements makes it is cheaper to implement the approach. Third, the disclosed approach is less probabilistic and more deterministic as a neural network is used to extract information from source code but not to write test cases.

In embodiments of the present invention, a system and a method are proposed. The system and the method use ensemble learning for optimally identifying functions, logic branches, and other elements (such as variables, relations between functions or classes, and programming patterns) in a streaming source file, in order to generate test cases in a proactive fashion.

A key challenge in building a scalable test case generator is to parse the source code successfully and know which elements need to be tested. Humans use vision and memory to identify functions, logic branches, and other elements in a source code file. With the recent development in computer vision, it is possible for computers to have this vision capability as well. Because source files are mostly in text formats, it is necessary to convert source files into images to leverage computer vision capabilities of neural networks.

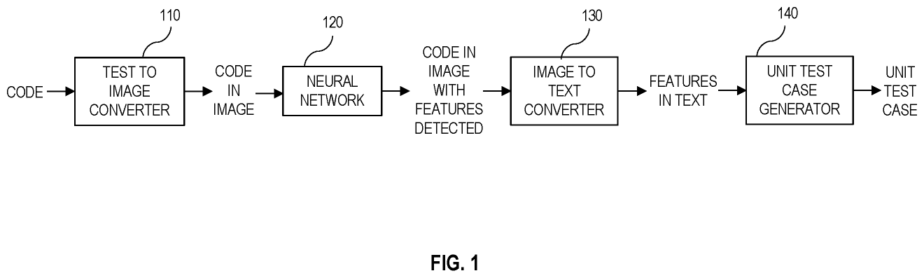

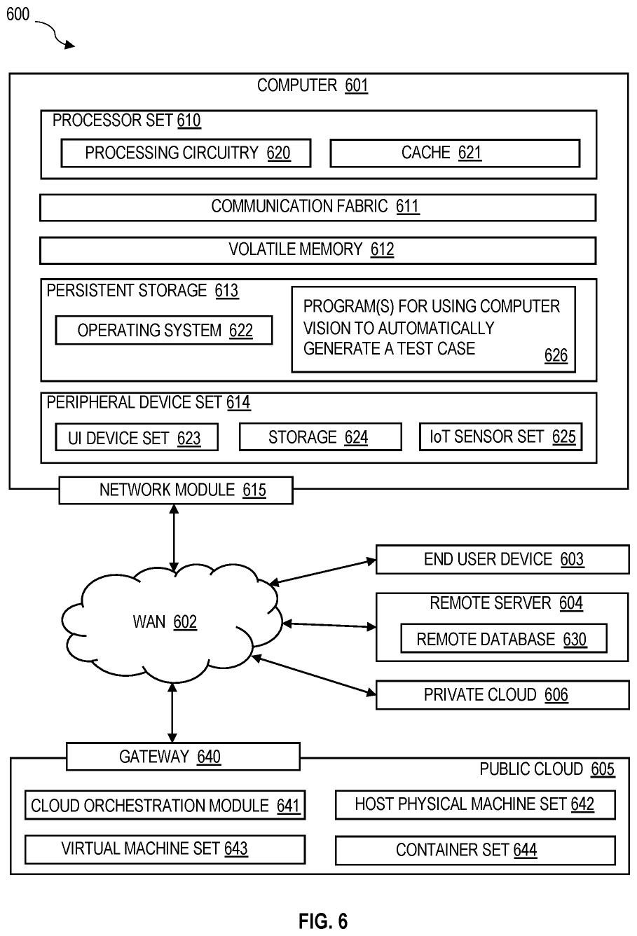

FIG. 1 illustrates system 100 for using computer vision to automatically generate a unit test case, in accordance with one embodiment of the present invention. System 100 is implemented on a computer or server such as computer 601 in FIG. 6.

In system 100, a source code file (which is in a text format) is fed to text to image converter 110. Text to image converter 110 converts the source code file to an image file which presents the code in an image. Text to image converter 110 uses standard solutions, such as Pillow (a free and open-source additional library for the Python programming language), to convert the source code file to the image file.

The image file is fed to neural network 120. The capacities of computer vision of neural network 120 is leveraged to identify elements in the image file of the source code. For example, neural network 120 may be a faster R-CNN (Region-based Convolutional Neural Network). Neural network 120 is trained to identify functions and variable types of inputs and outputs in the image of the source code. Neural network 120 extracts the features in the image, and the outcome of neural network 120 is the code in an image with features detected. Neural network 120 may use libraries such as YOLOv4 (a CNN-based one-stage detector) to extract the features in the image.

The code in the image with features detected is fed to image to text converter 130. Image to text converter 130 generates a text file that has a key value map. The key value map includes keys such as function name, input value types, and output value types. The text file may be, for example, CSV (comma-separated values) or JSON (JavaScript Object Notation) file. The features in the text file (generated by image to text converter 130) are fed into unit test case generator 140. Unit test case generator 140 creates a scaffold of a unit test case.

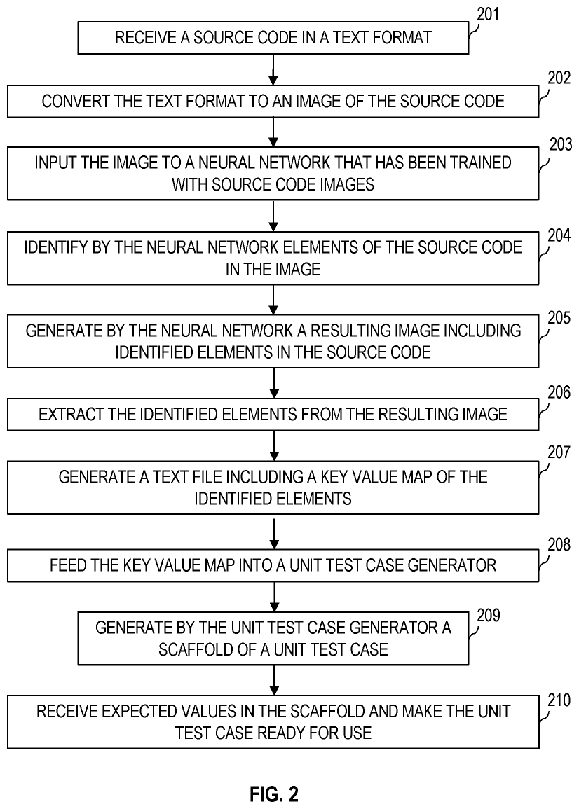

FIG. 2 is a flowchart showing operational steps of using computer vision to automatically generate a unit test case, in accordance with one embodiment of the present invention. The operational steps are implemented by a computer or server (such as computer 506 in FIG. 6).

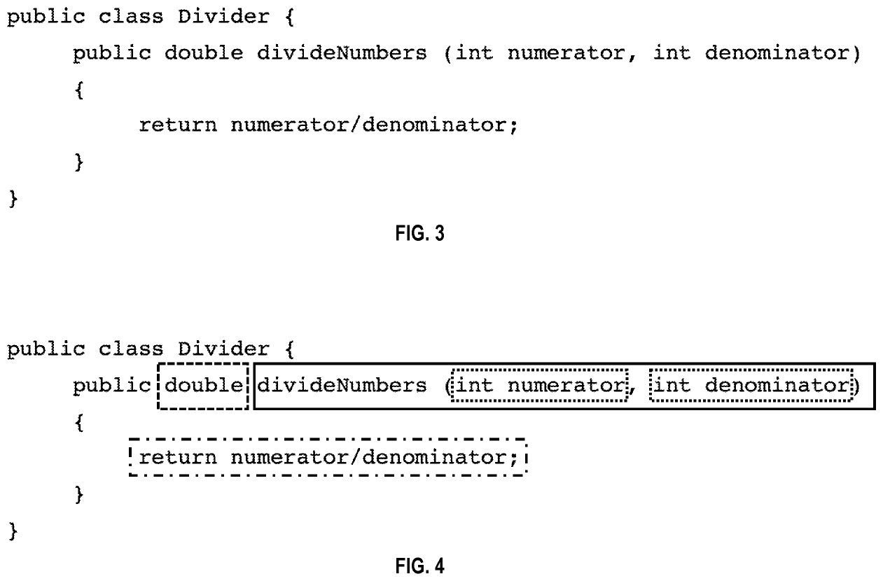

In step 201, the computer or server receives a source code in a text format. FIG. 3 illustrates a simple example of a source code of Java (a high-level, class-based, object-oriented programming language) in the text format. For example, in system 100 shown in FIG. 1, text to image converter 110 receives the source code in the text format.

In step 202, the computer or server converts the text format to an image of the source code. A text file of the source code is converted by the computer or server into an image file of the source code. For example, the text file of the source code may be converted into the image file using standard solutions such as the Pillow library (Pillow is a free and open-source additional library for the Python programming language). For example, in system 100 shown in FIG. 1, text to image converter 110 converts the text file of the source code to the image file of the source code.

In step 203, the computer or server inputs the image to a neural network that has been trained with source code images. Having been trained with the source code images, the neural network has capacities of computer vision and can identify elements in the image file of the source code. For example, the neural network may be a faster R-CNN (Region-based Convolutional Neural Network). For example, in system 100 shown in FIG. 1, text to image converter 110 inputs the image file to neural network 120.

In step 204, the neural network on the computer or server identifies elements of the source code in the image. For example, the faster R-CNN identifies the elements in the image file; the faster R-CNN has been trained with source code images. For example, in system 100 shown in FIG. 1, neural network 120 identifies the elements of the source code in the image.

In step 205, the neural network on the computer or server generates a resulting image including identified elements in the source code. The identified elements in the source code include functions, arguments of the functions, and variable types of inputs and outputs in the image of the source code. FIG. 4 illustrates an example of the resulting image including identified elements in the source code. The identified elements include function divideNumbers ( ) which is enclosed by a solid line, function arguments (int numerator, int denominator) which are enclosed by dotted lines, function type double which is enclosed by a dashed line, and the return variable which is enclosed by dash-dotted line. For example, in system 100 shown in FIG. 1, neural network 120 generates the resulting image.

In step 206, the computer or server extracts the identified elements from the resulting image. For example, the identified elements shown in FIG. 4 are extracted. For example, the computer or server uses libraries like YOLOv4 (a CNN-based one-stage detector) to extract the identified elements.

In step 207, the computer or server generates a text file including a key value map of the identified elements. For example, the computer or server generates a CSV (comma-separated values) file or a JSON (JavaScript Object Notation) file including the key value map. The key value map includes keys such as function name, input value types, and output value types. In this step, the image file is converted to another text file that includes the key value map. For example, in system 100 shown in FIG. 1, image to text converter 130 generates the text file including the key value map.

In step 208, the computer or server feeds the key value map into a unit test case generator. For example, in system 100 shown in FIG. 1, the key value map included in the text file (such as the CSV or JSON file) is fed into unit test case generator 140.

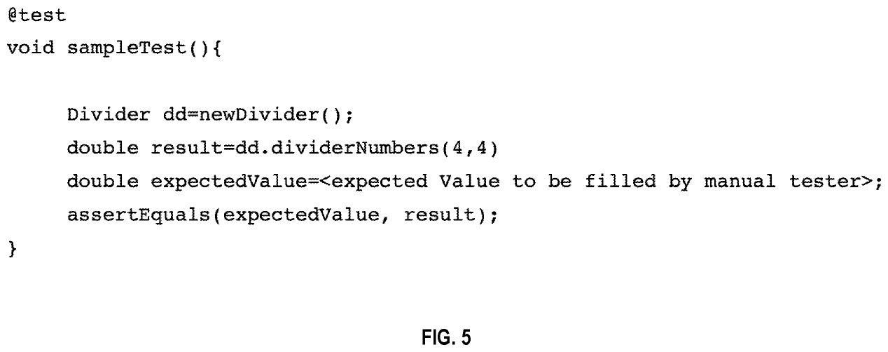

In step 209, the unit test case generator on the computer or server generates a scaffold of a unit test case. Generating the scaffold of the unit test case is based on the key value map generated in step 207. FIG. 5 illustrates an example of the scaffold of the unit test case. For example, in system 100 shown in FIG. 1, unit test case generator 140 generates the scaffold of the unit test case.

In step 210, the computer or server receives expected values in the scaffold and makes the unit test case ready for use. In one embodiment, the computer or server receives the expected values from a tester or user who keys in the expected values. In another embodiments, the computer or server receives the expected values from a second neural network; the second neural network is trained by learning from testers or users.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In FIG. 6, computing environment 600 contains an example of an environment for the execution of at least some of the computer code involved in performing the inventive methods, such as such as program(s) 626 for using computer vision to automatically generate a unit test case. In addition to block 626, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 626, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 626 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface type operating systems that employ a kernel. The code included in block 626 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

What is claimed is:

1. A computer-implemented method for using computer vision to automatically generate a unit test case, the method comprising:
converting a text file of a source code to an image file of the source code;
inputting the image file to a neural network having been trained with source code images;
identifying, by the neural network, elements in the image file;
generating, by the neural network, a resulting image including identified elements in the image file;
extracting the identified elements from the resulting image;
generating a text file including a key value map of the identified elements; and
generating a scaffold of a unit test case, based on the key value map.

2. The computer-implemented method of claim 1, further comprising:
feeding the key value map to a unit test case generator; and
wherein the unit test case generator creates the scaffold of the unit test case.

3. The computer-implemented method of claim 1, further comprising:
receiving expected values in the scaffold and making the unit test case ready for use.

4. The computer-implemented method of claim 3, wherein the expected values are inputted by a user.

5. The computer-implemented method of claim 3, wherein the expected values are received from a second neural network, wherein the second neural network is trained by learning from users.

6. The computer-implemented method of claim 1, wherein the identified elements include functions, arguments of the functions, and variable types of inputs and outputs of the functions.

7. A computer program product for using computer vision to automatically generate a unit test case, the computer program product comprising a computer readable storage medium having program instructions embodied therewith, the program instructions executable by one or more processors, the program instructions executable to:
convert a text file of a source code to an image file of the source code;
input the image file to a neural network having been trained with source code images;
identify, by the neural network, elements in the image file;
generate, by the neural network, a resulting image including identified elements in the image file;
extract the identified elements from the resulting image;
generate a text file including a key value map of the identified elements; and
generate a scaffold of a unit test case, based on the key value map.

8. The computer program product of claim 7, further comprising the program instructions executable to:
feed the key value map to a unit test case generator; and
wherein the unit test case generator creates the scaffold of the unit test case.

9. The computer program product of claim 7, further comprising the program instructions executable to:
receive expected values in the scaffold and making the unit test case ready for use.

10. The computer program product of claim 9, wherein the expected values are inputted by a user.

11. The computer program product of claim 9, wherein the expected values are received from a second neural network, wherein the second neural network is trained by learning from users.

12. The computer program product of claim 8, wherein the identified elements include functions, arguments of the functions, and variable types of inputs and outputs of the functions.

13. A computer system for using computer vision to automatically generate a unit test case, the computer system comprising one or more processors, one or more computer readable tangible storage devices, and program instructions stored on at least one of the one or more computer readable tangible storage devices for execution by at least one of the one or more processors, the program instructions executable to:
convert a text file of a source code to an image file of the source code;
input the image file to a neural network having been trained with source code images;
identify, by the neural network, elements in the image file;
generate, by the neural network, a resulting image including identified elements in the image file;
extract the identified elements from the resulting image;
generate a text file including a key value map of the identified elements; and
generate a scaffold of a unit test case, based on the key value map.

14. The computer system of claim 13, further comprising the program instructions executable to:
feed the key value map to a unit test case generator; and
wherein the unit test case generator creates the scaffold of the unit test case.

15. The computer system of claim 13, further comprising the program instructions executable to:
receive expected values in the scaffold and making the unit test case ready for use.

16. The computer system of claim 15, wherein the expected values are inputted by a user.

17. The computer system of claim 15, wherein the expected values are received from a second neural network, wherein the second neural network is trained by learning from users.

18. The computer system of claim 13, wherein the identified elements include functions, arguments of the functions, and variable types of inputs and outputs of the functions.
